(19) United States
(12) Patent Application Publication
(10) Pub. No.: US 2004/0108256 A1
(43) Pub. Date: Jun. 10, 2004

(54) Cyclone separator with central built-in element

(76) Inventor: Peter Hoffmann, Bergisch-Gladbach (DE)

Correspondence Address: Fay Sharpe Fagan, Minnich & McKee, Seventh Floor, 1100 Superior Avenue, Cleveland, OH, 44114-2518, US

(21) Appl. No.: 10/312,103

(22) PCT Filed: Jun. 6, 2001
(86) PCT No.: PCT/EP01/06411

(30) Foreign Application Priority Data
Jun. 23, 2000 (DE) 100 30 705.1

(51) Int. Cl. B04C 5/08; B04C 5/085

(52) U.S. Cl. 209/715; 209/720

(57) ABSTRACT

The invention concerns a cyclone separator (1) with a vertically extending housing (2), with an upper housing segment (3) in which is located a separator (6) with a separator wheel and which is equipped with a carrier gas/product inlet, as well as with a carrier gas/fines discharge, with a middle housing segment (4) which conically tapers in downward direction and in which is located a central built-in element (10) serving for gas/product guidance, as well as with a lower housing segment (5) which is equipped with a coarse grain discharge (14); in order to increase the operating range of said cyclone separator, it is suggested that the lower opening of the central built-in element (10) is located at the level of the conical housing segment (4) and that below the lower opening is arranged another built-in element (11), which has the shape of a cone expanding in downward direction.

The invention relates to a cyclone separator with the characteristics of the preamble to Claim 1. In addition, the invention concerns a method for influencing the granular distribution of powders while employing a cyclone separator of this kind.

During manufacture, treatment and/or processing of powders with a grain size in the μ-range, ever increasing demands are made relative to granular distribution, for example in the field of production of coating powders. Not only is observance of a given upper particle size of relevance, observance of a given particle size distribution is also demanded, i.e. different depending upon application—as a rule with respect to the percentage of fines.

A cyclone separator of the type concerned here is known from DE 196 08 142 A1. Tests with said cyclone separator in order to exert an influence on the granular distribution of powders revealed that it does not always satisfy the altered requirements with respect to the percentage of fine particulate in the coarse granulate.

The state of the art also includes the contents of specifications FE-25 80 195A, EP-468 426A and FR-11 23 112 A. They disclose separators, in each case, with a housing, a separator wheel arranged therein, as well as built-in elements arranged therein. The built-in elements limit slot ranges, in which a separation effect takes place.

The present invention is based on the object of providing a cyclone separator of the previously known type with improved classification properties in order to thereby enlarge its operating field.

According to the invention, said object is attained by means of the distinguishing characteristics of the Patent Claims.

By means of the built-in elements in the invention-specific cyclone separator, controlled flow guidance is attained, which, compared with the state of the art, provides improved classification results. It is essential in such configuration that the lower, cone-shaped built-in element forms a defined slot with the housing. Said slot is of decisive importance for the improved classification properties of the invention-specific cyclone separator. By adjustment of the slot size, it is possible to influence the granular distribution of the powder to be processed.

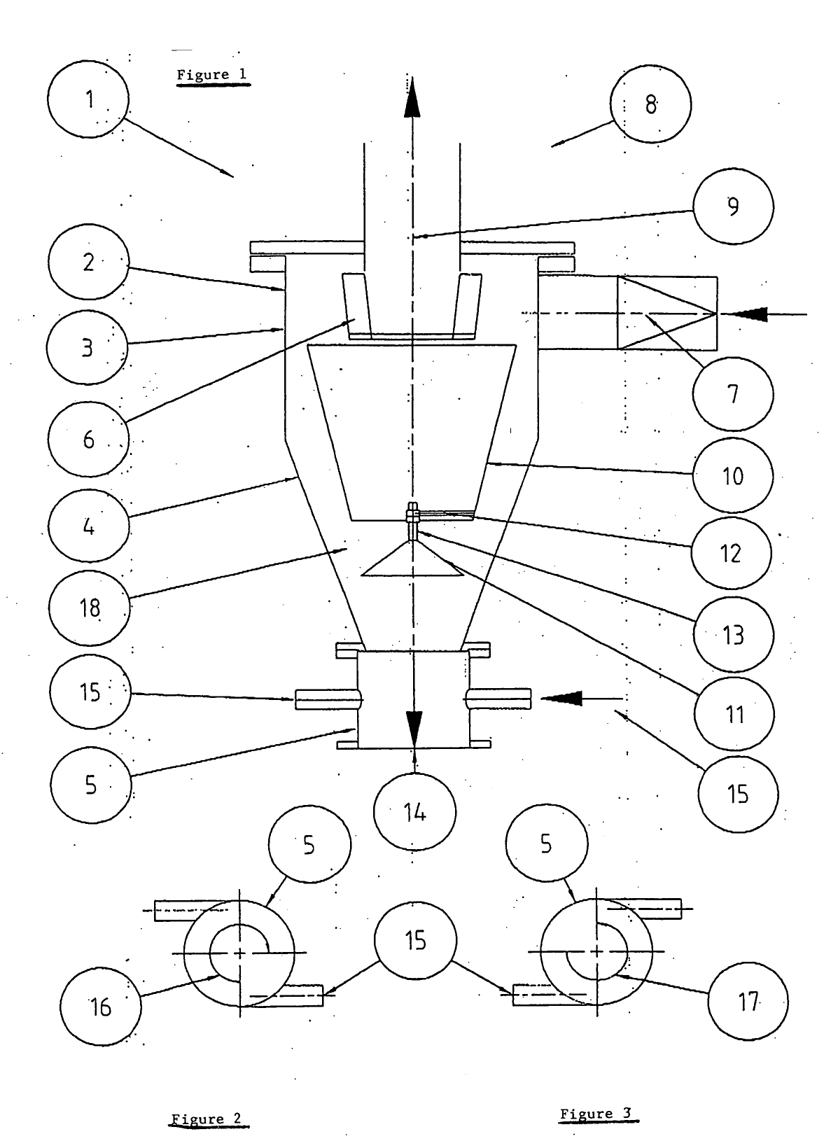

Further benefits and details of the invention are going to be explained with the aid of the schematically represented exemplary embodiments of the invention depicted in FIGS. 1 to 5.

In all Figures, the housing of cyclone separator 1 is identified with 2, its upper segment with 3, its middle, in downward direction conically tapering segment with 4, and its lower segment with 5. In the upper segment 3 is located a separator 6. Only the separator wheel is represented schematically. In addition, the upper segment is laterally equipped with a carrier gas-/product inlet 7 (preferably arranged tangentially) and with a carrier gas/fine grain product discharge (centrally arranged). The axis of the system is identified with 9.

Approximately at the level of the middle segment 4 are located two centrally arranged, rotation-symmetrical built-in elements. Involved is, firstly, a built-in element 10, open at the top and the bottom, tapering in downward direction (at least in the region of its lower segment), whose upper diameter is greater than the diameter of the separator wheel 6. It can extend up to the upper, preferably cylindrical segment 3 of housing 2 and stop directly below the separator wheel 6. Below the built-in element 10 is located the second built-in element 11, which is arranged, at a distance, below the lower opening of the built-in element 10, and which has the shape of a conical cover expanding in downward direction. Said cone-shaped built-in element 11 is attached to built-in element 10 in height-adjustable fashion. For that purpose, a brace 12 attached to the built-in element 10 is provided, with a support 13 of the cone 11 being mounted in height-adjustable fashion to said brace, for example by means of a screw thread.

The lower housing segment 5 is equipped with a coarse grain discharge, not shown in detail, (indicated by arrow 14). In addition, one or several (two are represented) pipe connections 15 are provided for the supply of secondary gases, preferably secondary air. These may issue radially into the lower housing segment 5 (FIGS. 1, 4 and 5).

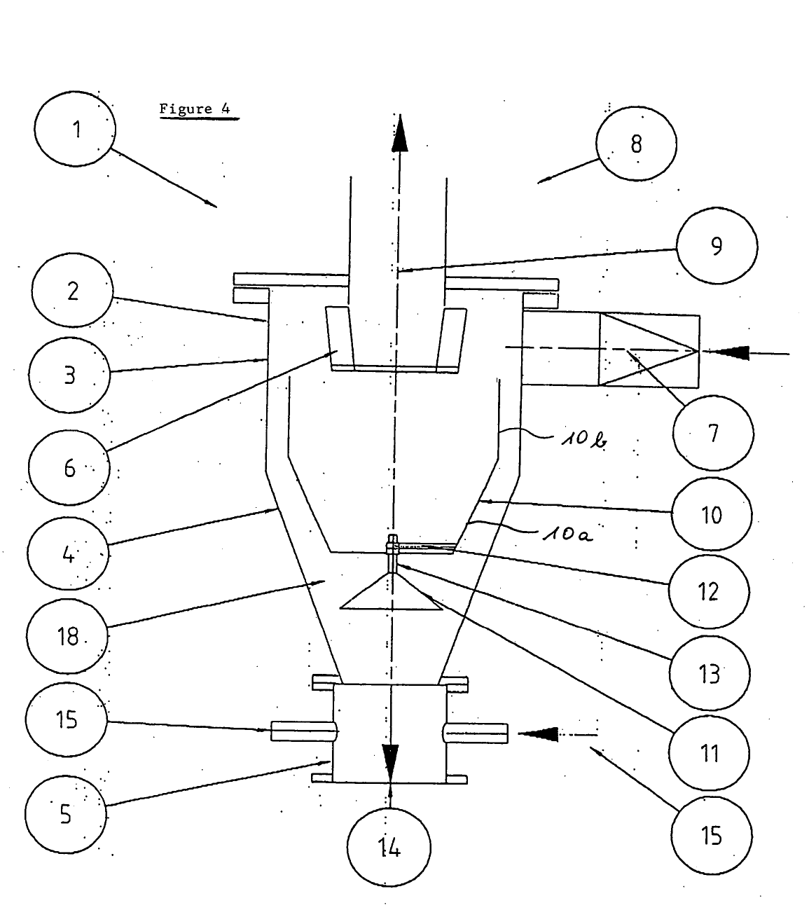

Tangentially issuing pipe connections 15 are represented in FIGS. 2 and 3. The solutions according to said Figures differ in the rotational direction of the vortices which are generated by the entering secondary air flows (arrows 16, 17).

During operation of the cyclone separator 1 according to the invention, the product-/carrier gas flow enters tangentially at the level of the separator wheel 6 into the upper segment 3 of housing 2. Extremely fine particles follow the carrier gas through the separator wheel 6 and leave the housing 2 via the carrier gas-/fine grain discharge. The remaining portion of the supplied product-/carrier gas stream flows, in downward direction, in spirally-shaped paths, into the annular chamber between the built-in element 10 and the external housing 2. The purpose of built-in element 10, which is known by itself, is to separate from each other the carrier gas-/particle streams which are oriented in downward direction in the peripheral region and in upward direction in the central region.

The lower built-in element 11 forms a defined slot with the outer housing 2. In the area of said slot occurs another separation of the downwardly oriented carrier gas-/particle streams. Said separation is particularly effective, if a counter flow is generated at the lower housing segment 5, in the region of slot 18, with the aid of secondary air, supplied via the pipe connections 15. It may be of benefit to also supply the secondary air tangentially, that is to say either in the same direction or in the opposite direction relative to the supply of the carrier gas-/particle stream. The fine grain product separated in slot 18 is once more conducted to the separator 6 through the interior of the built-in element 10. The product which passes through slot 18 is discharged as coarse granulate.

The cone-shaped built-in element 11 has the object of firstly preventing repeat ascent of the product located in the lower region of housing 2 due to flow turbulence. In addition to the number of revolutions of separator 6 and the supplied secondary air volume, the slot size 18 influences the percentage of fines of the fine-grained product. Due to the fact that the size of slot 18 is adjustable, it is also possible to vary the percentage of fines of the fine-grained product.

In FIG. 1, the built-in element 10 presents, over its entire height, a conically, in downward direction tapering form. The plane of its upper opening lies directly below the separator wheel 6. The plane of its lower opening lies in the area of the middle level of the conical segment 4 of the outer housing 2.

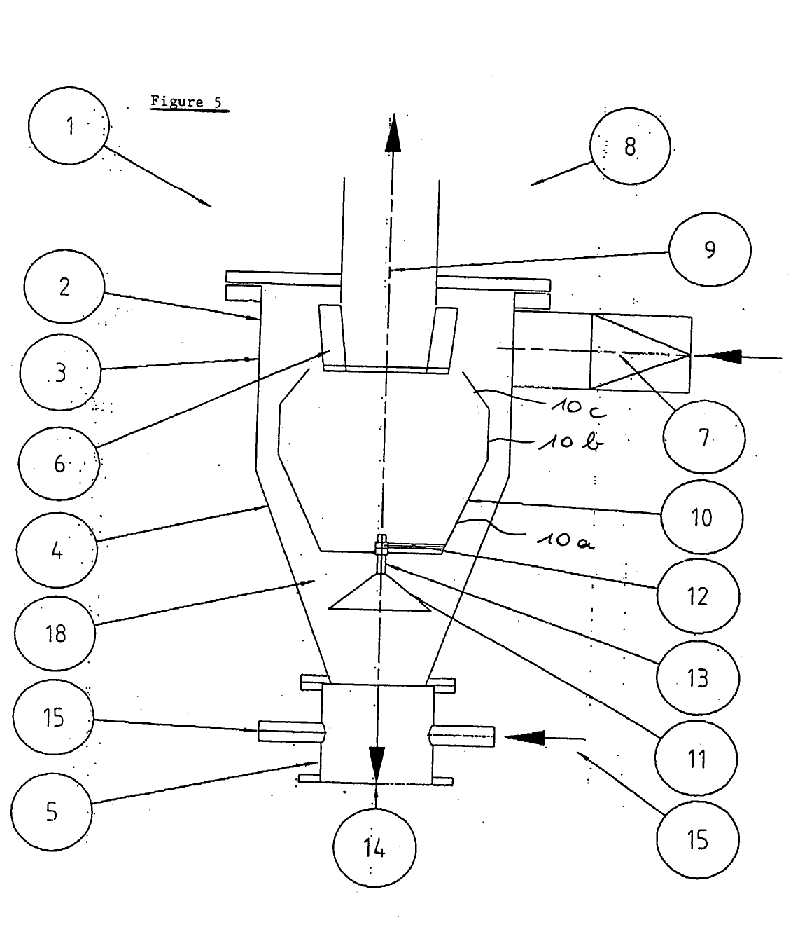

FIGS. 4 and 5 depict further embodiments of the built-in element 10. It presents, similar to housing 2, differing segments.

In the embodiment according to FIG. 4, a lower conical segment 10a is provided and an upper cylindrical segment 10b. The transition from cylindrical to conical is arranged approximately at the same level as with the outer housing 2. (Transition from segment 3 to segment 4).

In the embodiment according to FIG. 5, the upper opening of the built-in element 10 is followed by an initially conically in downward direction expanding segment 10c. Said segment, as represented in FIG. 5, can change over into the cylindrical segment 10b, or directly into the in downward direction conically tapering segment 10a.

As already mentioned, the cyclone separator according to the invention not only possesses improved classification properties; in addition, it allows to exert an influence, in targeted fashion, upon the size of the percentage of fines in fine-grained powder. Tests have shown that fines percentage <10μ is variable within relatively large ranges. By changing only the secondary air volume or the peripheral velocity of the separator wheel it is possible to already adjust the fines percentage within a range which lies between a first (smaller) value and a second by up to 70% increase in value. Further influence can be exerted upon said particle size distribution by changing the size of the slot 18.

During tests with respect to the influence of number of revolutions and secondary air volume, the size of slot 18 was approximately 10 mm (with a diameter of the lower edge of the cone 11 measuring approximately 0.130 cm). By changing the height of the cone 11, slot 18 can be adjusted within a wide range.

1. Cyclone separator (1) with a vertically extending housing (2), with an upper housing segment (3) in which is located a separator (6) with a separator wheel, and which is equipped with a carrier gas/product inlet (7) as well as a carrier gas/fine grain product discharge (8), with a middle housing segment (4) which conically tapers in downward direction and in which is located a central built-in element (10) serving for gas/product guidance, extending up to the upper housing segment (3), preferably up to the lower end of the separator wheel blades, as well as with a lower housing segment (5), which is equipped with a coarse grain discharge (14) and with at least one pipe connection (15) for secondary air supply, characterized in that the lower opening of the central built-in element (10) is located at the level of the conical housing segment (4), that below the lower opening is arranged another built-in element (11) which has the shape of a downwardly expanding cone and is attached to the upper central built-in element (10), and that the lower edge of the built-in element (11) forms a slot (18) with housing (2) in which takes place another separation.

2. Cyclone separator according to claim 1, characterized in that the central built-in element (10) is likewise designed at the level of the conical housing segment (4) in downwardly conically tapering shape.

3. Cyclone separator according to claim 2, characterized in that the conicity of the built-in element (10) and the housing segment (4) is approximately the same.

4. Cyclone Separator according to claim 1, 2 or 3, characterized in that the outer edge of the cone-shaped built-in element (11) is located in the lower region of the conical housing segment (4).

5. Cyclone Separator according to one of the preceding claims, characterized in that the lower cone-shaped built-in element (11) is height-adjustable.

6. Cyclone Separator according to one of claims 1 to 5, characterized in that the central built-in element (10) is designed cylindrically (segment 10b) in the region of the upper housing segment (3).

7. Cyclone Separator according to one of claims 1 to 6, characterized in that the upper opening of the central built-in element (10) is followed by a downwardly expanding segment (10c), which is followed, in downward direction, by either the cylindrical segment (10b) or the conical segment (10a).

8. Cyclone Separator according to one of the preceding claims, characterized in that one or several pipe connection(s) (15) is/are provided at the lower housing segment (15) for radially or tangentially oriented air supply.

9. Device according to claim 8, characterized in that the carrier gas-/product inlet (7) and at least one pipe connection (15) are tangentially arranged in such fashion that the generated gas vortices have an opposite rotational direction.

10. Method for operating a Cyclone Separator (1) with a vertically extending housing (2), with an upper housing segment (3) in which is located a separator (8) with a separator wheel, and which is equipped with a carrier gas/product inlet, as well as with a carrier gas/fine grain discharge, with a middle housing segment (4) which conically tapers in downward direction and in which is located a central built-in element (10) serving for gas/product guidance, extending up into the upper housing segment (3), preferably up to the lower end of the separator wheel blades, as well as with a lower housing segment (5) which is equipped with a coarse grain discharge (14) and with at least one pipe connection (15) for secondary air supply, whereby the Cyclone Separator (1) additionally presents the characteristics that the lower opening of the central built-in element (10) is located at the level of the conical housing segment (4), that below the lower opening is arranged another built-in element (11), which has the shape of a downwardly enlarging cone, is fastened to the upper built-in element (10) and that the lower edge of the built-in element (11) forms with housing (2) a slot (18), in which takes place another separation, characterized in that the fines percentage of the grain distribution is influenced by making a change in the number of revolutions of the separator (6), in the supplied secondary air volume and/or in the height of the cone-shaped built-in element (11).
